(19) United States
(12) Patent Application Publication
(10) Pub. No.: US 2019/0003638 A1
(43) Pub. Date: Jan. 3, 2019

(54) SUPPORT FOR PORTABLE ELECTRONIC APPARATUSES

(71) Applicant: Vitec Imaging Solutions S.p.A., CASSOLA (PD) (IT)

(72) Inventor: Alessandro BERTELLE, BASSANO DEL GRAPPA (VI) (IT)

(73) Assignee: Vitec Imaging Solutions S.p.A., CASSOLA (PD) (IT)

(21) Appl. No.: 16/067,064

(22) PCT Filed: Dec. 29, 2016
(86) PCT No.: PCT/IB2016/058067

§ 371 Date: Jun. 28, 2018

(30) Foreign Application Priority Data
Dec. 29, 2015 (IT) 102015000088625

(51) Int. Cl. F16M 13/02; F16M 11/04; G06F 1/16

(52) U.S. Cl. CPC F16M 13/022; G06F 1/1632; F16M 11/041

(57) ABSTRACT

A support for portable electronic apparatus includes a body having a mainly longitudinal development along a longitudinal axis delimited by a longitudinally opposed first and second edge, first and second gripping appendages provided on opposite ends of the body and each having a face, facing the first and the second edge respectively, shaped so as to be coupled with a positive coupling to the respective edge, connecting means for connecting the first and second gripping appendages to the body for operation, allow the first and second appendage to rotate relative to the body about a rotation axis, the first and second edge are inclined relative to the longitudinal axis at an angle of ≤45°, the axis of rotation perpendicular to the first and second edge, so that, the first and second gripping appendage can be rotated relative to the body between a compact transport configuration, and an operating configuration.

### TECHNICAL FIELD

The present invention relates to a support for portable electronic apparatus.

The support according to the invention is particularly suitable for use for supporting smartphones, satellite navigation or GPS systems, compact videocameras, or portable digital music players.

Portable electronic apparatus is used more and more commonly in various situations, one or more of the various functions offered by the apparatus being used on different occasions.

For example, smartphones may be used not only to make and/or receive calls, but also to hear music or record videos, or as navigation devices, for example satellite navigators or interactive navigators.

In order to perform the aforesaid functions in the best way, the smartphone must be positioned correctly on a desired support surface, for the purpose of playing the music correctly, or ensuring that the videos made are of high quality, for example.

Very commonly, however, the users of this apparatus do not own supports suitable for correct use, and must do their best to position the electronic apparatus on improvised supports or supports adapted on a temporary basis. This has a negative effect on the quality of the videos made or the quality of the music produced.

Furthermore, if the apparatus is used as a navigation device, it must be positioned in a stable manner, so as to be visible and accessible to the user, and must be positioned securely in the motor vehicle to prevent it from falling when the vehicle is in motion.

There are known support devices for navigation devices, which are fastened to the dashboard of a vehicle and are designed and prepared expressly for the purpose of supporting navigation devices. These support devices are usually bulky and are not suitable for removal from the vehicle: in most cases, the navigator is removed from the support, leaving the latter fixed in the vehicle.

Furthermore, these support devices are designed to support a specific type of navigation device, and are unsuitable for use in supporting devices of a different size or shape from those for which the supports were expressly designed.

The need therefore arises to provide a support for portable electronic apparatus which is configured so as to overcome the aforesaid difficulties.

One object of the invention is to provide a support for portable electronic apparatus which has limited overall dimensions, so that it can easily be transported.

Another object is to provide a support for portable electronic apparatus that is constructed in such a way as to be usable for supporting portable electronic apparatus of different sizes and shapes.

Another object is to provide a support for portable electronic apparatus which is easy to position, while also providing a stable and secure support for portable electronic apparatus fastened to it.

### BRIEF DESCRIPTION OF THE DRAWINGS

The characteristics and advantages of the invention will be more fully apparent from the detailed description of a preferred example of embodiment thereof, illustrated, for guidance and in a non-limiting way, with reference to the attached drawings, in which:

FIGS. 1 and 2 are two perspective views from two different angles of a support according to the invention, in a compact transport configuration;

FIG. 3 is a perspective view of the support of FIG. 1, in an operating configuration;

FIG. 4 is a top view of the support of FIG. 3;

FIG. 5 is a view similar to that of FIG. 4, but in cross section;

FIG. 5A is an enlarged view of the detail A of FIG. 5;

FIG. 6 is a top view of the support of FIG. 3 in use with a piece of electronic apparatus;

FIGS. 7 and 8 are two perspective views from two different angles of the support of FIG. 6; and

FIG. 9 is an enlarged sectional view taken along the plane IX-IX of FIG. 4, relating to a device for locking the support according to the invention.

With reference to the attached figures, it is shown a support 1 for portable electronic apparatus, made according to the invention.

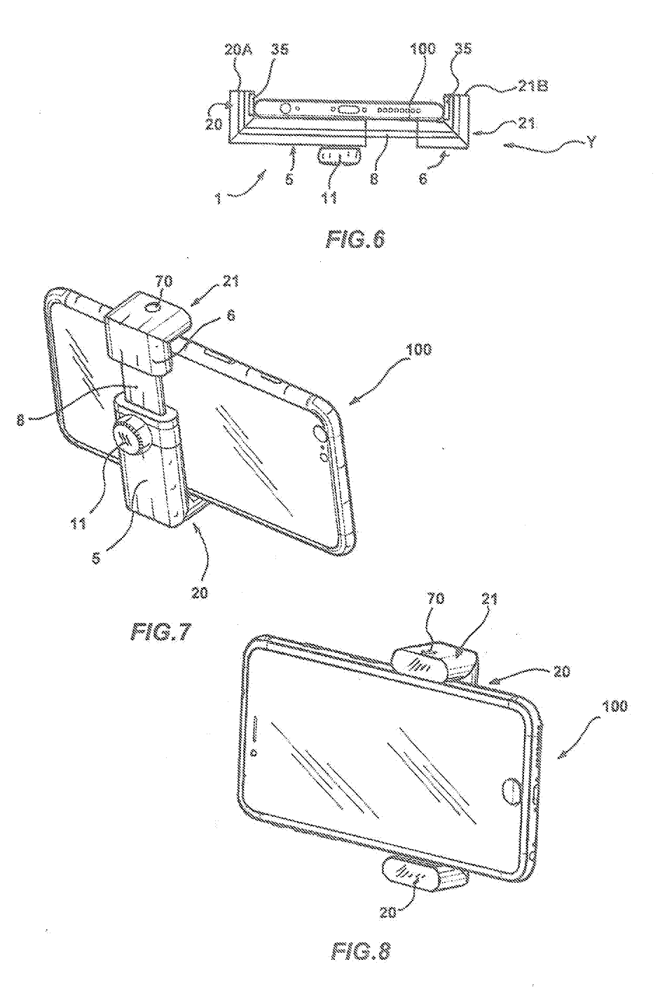

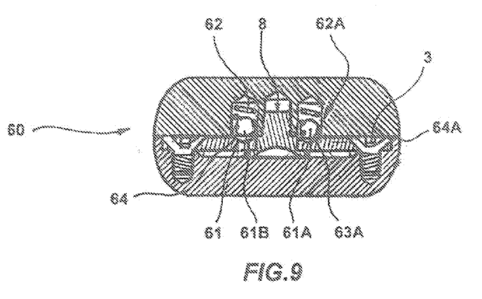

The support according to the invention is particularly suitable for use as a support for smartphones, such as the smartphone shown in FIGS. 6-8. However, the support according to the invention may also be used to support other portable electronic apparatus, for example satellite navigation devices or GPS systems, compact videocameras, or portable digital music players.

The support 1 comprises a body 2 of elongate shape, having its predominant longitudinal extension along a longitudinal axis X.

Preferably, the body 2 is practically parallelepipedal in shape, and is delimited by two opposed base surfaces S, S′, two opposed rounded edges 2A, 2B, and a first and a second edge 3, 4 which are longitudinally opposed.

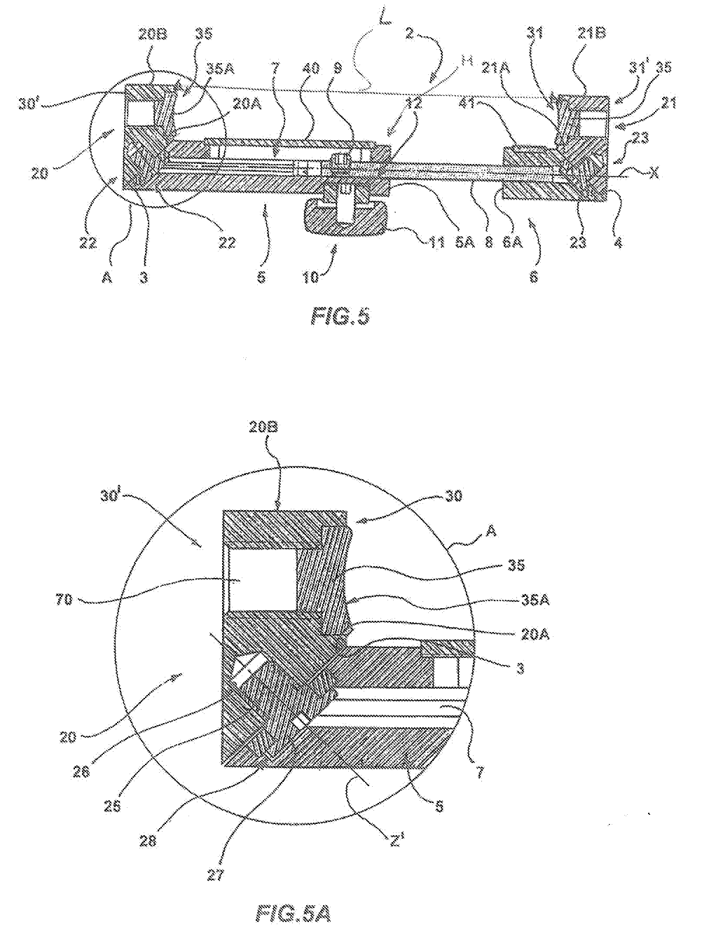

The first and second edges 3, 4 are inclined relative to the longitudinal axis X at an angle α, shown in FIG. 4, of 45°. In the illustrated version, the two opposed edges 3, 4 are inclined relative to the longitudinal axis X at an angle α of about 45°.

The body 2 of the support 1 is preferably telescopic: that is to say, it comprises at least two sliding elements that can be moved relative to one another along the longitudinal axis X, to vary the overall extension of the body 2 along the longitudinal axis X, in other words the distance between the first edge 3 and the second edge 4.

In the illustrated version, the body 2 comprises a first portion 5 and a second portion 6, which are movable relative to one another along the longitudinal axis X.

The first portion 5 and the second portion 6 are delimited along the longitudinal axis X by the first edge 3 or the second edge 4 respectively, and by a first inner face 5A and a second inner face 6A respectively.

The inner faces 5A, 6A of the first and second portion 5, 6 are, therefore, opposed along the longitudinal axis X to the first edge 3 and the second edge 4 respectively.

As may be seen more clearly in FIG. 5, the first portion 5 comprises an internal cavity 7 extending along the longitudinal axis X and designed to house in a slidable manner an appendage 8 fastened to the second portion 6 in a position facing the first portion 5 of the body 2.

The appendage 8 is designed to slide along the longitudinal axis X inside the internal cavity 7 as a result of a movement of the first and second portion relative to one another, as explained more fully below, between a retracted position and a pulled-out position, to vary the overall length of the support 1.

The appendage 8 is provided with a stop element 9 designed to stop the pulling of the appendage 8 out of the internal cavity 7.

The body 2 further comprises a locking device 10 designed to be actuated in order to allow or prevent the movement of the first portion 5 and second portion 6 relative to one another, that is to say the sliding of the appendage 8 relative to the internal cavity 7.

The locking device 10 comprises a nut 11 positioned outside the first portion 5 in such a way that it can be accessed by a user of the support 1, so as to be rotated by the actuation of grip elements 12 of the locking device 10, connected for operation to the nut 11, and placed inside the first portion 5.

By moving the grip elements 12, the first portion 5 and second portion 6 can be moved relative to one another in order to lock them in a desired configuration relative to one another, or to release them in order to allow their movement relative to one another, and thus vary the overall extension of the body 2 along the longitudinal axis X.

The grip elements 12 are advantageously movable along an axis perpendicular to the longitudinal axis X.

The first portion 5 and second portion 6 are movable between a retracted configuration, shown in FIGS. 1-4, in which the appendage 8 is substantially inserted into the internal cavity 7 and the inner faces 5A, 6A of the first portion 5 and second portion 6 respectively are in contact with one another, and various extension configurations, for example that shown in FIG. 5, in which the facing surfaces 5A, 6A of the first portion 5 and second portion 6 are spaced apart from one another and the appendage 8 is placed at least partially outside the cavity 7.

The support 1 further comprises a first and a second gripping appendage 20, 21 and a first and a second connecting element 22, 23, shown in greater detail in FIG. 5A, which are designed to connect the first gripping appendage 20 and the second gripping appendage 21 to the body 2, in the first portion 5 and the second portion 6 respectively in the illustrated version.

Each gripping appendage 20, 21 is substantially trapezoidal in shape, and comprises a face 20A, 21A positioned so as to face the first edge 3 and the second edge 4 respectively, and shaped so as to mate with the shape of the corresponding edge 3, 4.

Each gripping appendage 20, 21 further comprises a pair of lateral walls 30, 30′, 31, 31′ and a free wall 20B, 21B opposed to the face 20A, 21A.

Advantageously, the face 20A, 21A is substantially parallel to the corresponding edge 3, 4 of the body 2.

Each connecting element 22, 23 comprises a screw 24 having a head 27 and a threaded body 25 extending from the head 27 along its own longitudinal axis Z′.

The head 27 of each screw 24 is inserted into a seat 28 which is defined, respectively, in the first portion 5 or in the second portion 6 of the body 2, and which is shaped so that the head 27 can rotate inside the seat 28, while the threaded body 25 is inserted into a fastening seat 26 provided in the first 20 or the second 21 gripping appendage respectively.

In the illustrated version, the threaded body 25 of the screw 24 is fastened and fixed to the respective gripping appendage 20, 21, while the head 27 is slidable in rotation inside the seat 28.

Therefore, the rotation of each gripping appendage 20, 21, causes the screw 24 to rotate and the head 27 rotates inside the seat 28 provided in the first and second portion 5, 6 respectively.

The screw 24 is positioned so that the longitudinal axis Z′ of the threaded body 25 is substantially perpendicular to the face 20A, 21A of the respective gripping appendage 20, 21. The longitudinal axis Z′ of each threaded body 25 forms the axis of rotation for the orientation of each gripping appendage 20, 21 relative to the body 2.

Each gripping appendage 20, 21 is thus rotatable about the longitudinal axis Z′ of the threaded body 25 of the respective screw 24 so that the appendage can be orientated relative to the body 2, as explained more fully below.

In other versions which are not shown, the threaded body of the screw may be provided inside the body 2, while the head of the screw is placed inside the respective gripping appendage, and/or the screw may be fixed to the body 2 and may be rotatable relative to the gripping appendages.

Additionally, in other versions of the support which are not shown, connecting elements other than the screws described above may be provided between the gripping appendages and the body of the support 1, these elements being adapted to allow a relative rotation between the gripping appendage and the body such that the gripping appendages can be orientated relative to the body, as explained more fully below.

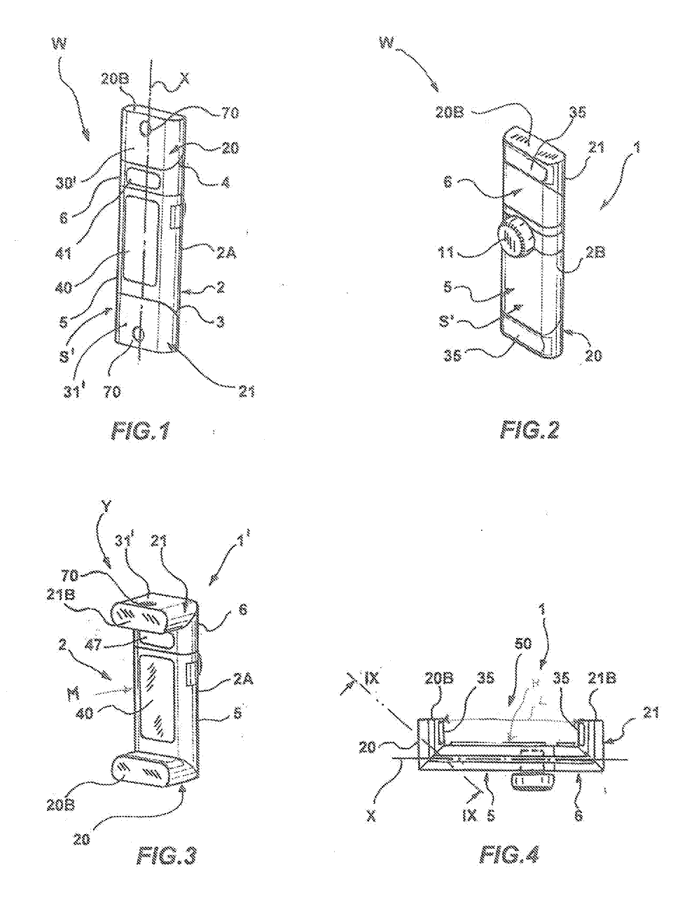

The first 20 and second 21 gripping appendage may be rotated about the axis of rotation Z′ so as to be moved relative to the body 2 between a compact transport configuration W, shown in FIGS. 1 and 2, in which the appendages 20, 21 are aligned with the body 2 so that the support 1 has a generally parallelepipedal shape, and an operating configuration Y, shown in FIGS. 3-8, in which the first 20 and second 21 gripping appendage are positioned transversely to the body 2.

Advantageously, the first 20 and second 21 gripping appendage are rotated through 180° about the axis of rotation Z′, to move between the compact configuration W and the operating configuration Y.

In the compact transport configuration W, the support 1 is therefore delimited along the longitudinal axis X by the free walls 20B, 21B of the two gripping appendages, the body 2 being aligned with, and interposed between, the two gripping appendages 20, 21.

Conversely, in the operating configuration Y the first 20 and the second 21 gripping appendage are positioned transversely to the body 2, and define, together with the body 2, a gripping cavity 50 designed to receive and support a piece of portable electronic apparatus 100, as shown in FIGS. 6-8 and as explained more fully below.

In the operating configuration Y, the first 20 and the second 21 gripping appendage define the lateral walls of the gripping cavities 50, and the base surfaces S of the body 2, and possibly the portion of appendage 8 placed outside the internal cavity 7, define the bottom wall “M” of the gripping cavity 50.

In the illustrated version, as stated above, the first edge 3 and the second edge 4 and the end surfaces 20A, 21A of the gripping appendages 20, 21 are inclined relative to the longitudinal axis X of the body 2 at an angle α of about 45°.

Therefore, in this version, in the operating configuration Y, the first and second appendages 20, 21 are placed substantially perpendicularly to the longitudinal axis X of the body 2; that is to say, a gripping cavity 50 is defined, with lateral walls substantially perpendicular to the bottom wall and shaped like a letter “C”.

In this version, the opening of the gripping cavity 50, that is to say the part of the gripping cavity 50 defined by the end surfaces 20A, 21A of the gripping appendages 20, 21 and located farthest from the bottom wall S has an extension “L” along the longitudinal axis X which is substantially equal to the extension M of the bottom wall S.

In other versions which are not shown, the first edge 3 and the second edge 4 and the end surfaces 20A, 21A of the gripping appendages 20, 21 are inclined relative to the longitudinal axis X of the body 2 at an angle α of less than 45°.

In these versions, in the operating configuration Y, the first and second gripping appendage 20, 21 are inclined relative to the body 2 so that a gripping cavity 50 is defined with lateral walls converging towards one another as they extend away from the bottom wall S; in other words a gripping cavity 50 is defined in which the opening has smaller dimensions than the bottom wall S.

Each gripping appendage 20, 21 is provided with a sealing element 35, positioned on the lateral wall 30, 31 of each gripping appendage 20, 21, and designed to be turned in the operating configuration Y towards the other gripping appendage 20, 21, that is to say towards the inside of the gripping cavity 50.

The sealing element 35 is designed to receive and support a lateral edge 101 of a piece of electronic apparatus 100, and is positioned so as to project from the lateral wall 30, 31 of the gripping appendage 20, 21. The sealing element 35 is made of rubber or other material which is advantageously deformable, to facilitate the insertion of the apparatus 100.

The sealing element 35 is made of a material having a good coefficient of friction, to make the gripping of the electronic apparatus 100 more stable and to prevent damage to the apparatus.

The sealing element 35 has a concave outer profile 35A, so as to facilitate the positioning of the electronic apparatus 100 in the gripping cavity 50 and make it more stable. In fact, the electronic apparatus 100 is positioned in a concavity of the sealing element 35, in a central area thereof in the illustrated version, so that edge portions of the sealing element 35 are partially wrapped around the lateral edge 101 of the electronic apparatus 100, preventing its accidental exit from the gripping cavity 50.

In a version of the support that is not shown, the sealing element 35 may be movable in a corresponding housing cavity defined on the gripping appendages so that it can be moved in the corresponding housing cavity away from and/or towards the corresponding lateral wall 30, 31, in order to vary the extension of the gripping cavity 50 locally to facilitate the insertion of the electronic apparatus into the support.

Advantageously, a spring or other pushing element may be provided to push the sealing element 35 towards the outside of the corresponding housing cavity, to clamp the electronic apparatus 100 in the gripping cavity 50 after it has been inserted therein. In this case, a force must be applied against the force exerted by the pushing element in order to insert the electronic apparatus 100 into the gripping cavity 50.

The support 1 further comprises a regulating device 60, shown in greater detail in FIG. 9, for regulating the relative orientation between the gripping appendages 20, 21 and the body 2 and for locking the relative rotation between the gripping appendages 20, 21 and the body 2.

The regulating device 60 enables the first and the second gripping appendage 20, 21 to be locked in a stable but reversible manner in either the compact transport configuration W or in the operating configuration Y, so as to prevent undesired movements of the gripping appendages 20, 21.

In the illustrated version, for each gripping appendage 20, 21, the regulating device 60 comprises a pair of balls 61, 61A housed in the respective gripping appendage 20, 21 and two springs 62, 62A also housed in the respective gripping appendage 20, 21 and pre-loaded so as to push the balls 61, 61A towards the outside of the gripping appendage 20, 21, so that the balls 61, 61A project from the face 20A, 21A of each gripping appendage 20, 21.

The face 20A, 21A is provided with a pair of holes 64, 64A designed to allow the partial emergence of the balls 61, 61A and prevent their complete exit. Two recesses 63, 63a are formed on the first and second edge 3, 4 of the body 2, these recesses being placed in positions corresponding to the balls 61, 61A and designed to receive these balls 61, 61A.

In other versions which are not shown, the balls may be provided in the body 2, so as to project partially from suitable holes provided on the first and second inclined edge 3, 4 respectively, the faces 20A, 21A of each gripping appendage 20, 21 being provided with recesses designed to receive the balls.

The two balls 61, 61A and the two recesses 63, 63A of each gripping appendage 20, 21 are positioned at 180° to one another relative to the axis of rotation Z′.

Therefore, when the gripping appendages 20, 21 are moved between the compact transport configuration W and the operating configuration Y, the two balls 61, 61A of each gripping appendage 20, 21 are housed in an alternative way in the two recesses 63, 63A; that is to say, the recess/ball pairs are exchanged for each gripping appendage 20, 21.

The recesses 63, 63A therefore also act as regulating elements because they regulate the rotation of the gripping appendages 20, 21, and this rotation ends when the balls 61, 61A are housed in the respective recesses 63, 63A.

In other versions which are not shown, a number of balls and/or recesses other than two may be provided for each gripping appendage 20, 21; for example, four balls and four corresponding recesses may be placed at 90° to the axis of rotation Z′.

At least one of the two gripping appendages 20, 21 is also provided with a fastening element designed to be used to fasten the support 1 to a tripod or monopod or other suitable support apparatus.

In the illustrated version, each gripping appendage 20, 21 is provided with a threaded hole 70 for fastening the support to another support element.

The threaded hole 70 is provided on the lateral wall 30, 31′ of each gripping appendage 20, 21, which is designed to face, in the operating configuration Y, in the opposite direction from the seat 50.

In other versions which are not shown, the fastening element may be provided on the body 2.

Thus the support according to the invention may be fastened to a monopod, a tripod, or a head for videocameras, in order to make high-quality videos when the electronic apparatus 100 is inserted into the seat 50.

The support according to the invention may also be fastened to a support for navigation devices, attached to a motor vehicle for example, so that the electronic apparatus 100 inserted into the seat 50 can easily be used as a navigator.

The body 2 of the support 1 is also provided with at least one insert of rubber or other suitable material, designed to improve the gripping of the electronic apparatus 100 on the support according to the invention.

In the illustrated version, two separate rubber inserts 40, 41 are provided on the base surface S of the body 2 which forms the bottom wall of the seat 50.

In an embodiment which is not shown, the support according to the invention is provided with an elastic tensioning device housed in the body 2 and designed to clamp the two gripping appendages 20, 21 against the body 2.

Advantageously, the elastic device is, for example, a helical wire spring, an elastic cord, or other similar device.

The two opposed ends of the elastic device are fastened, respectively, to the first portion 5 ad to the second portion 6 of the body 2, the elastic device is pre-loaded so as to pull the first 20 and the second 21 gripping appendage against one another and clamp them against the electronic apparatus 100.

Advantageously, the elastic device is attached between the portions 5 and 6 of the body 2 and is shaped so as to remain contained within these portions in the compact transport configuration W, so that it does not protrude from the body 2.

The support 1 according to the invention is usually configured in the compact transport configuration W, with the body 2 in the retracted position, that is to say the position having the minimum overall dimension along the longitudinal axis X.

The body 2 has a width in the range from 40 to 100 mm and a thickness in the range from 4 to 20 mm, and, in the retracted configuration W, an extension in the range from 20 to 80 mm along the longitudinal axis X.

Thus the support 1 may easily be transported, possibly in a pocket, since it has overall dimensions similar to those of a cigarette lighter.

When the support 1 has to be used to support portable electronic apparatus, the user grasps the gripping appendages 20, 21 and rotates them through 180° about the axis of rotation Z′, thus bringing the support 1 into the operating configuration Y.

If necessary, the user varies the length of the gripping cavity 50, by varying the overall extension of the body 2 along the longitudinal axis X.

For this purpose, the user releases the locking device 10 and pulls the appendage 8 partially out of the cavity 7, and then locks the locking device 10 again.

The user then inserts the electronic apparatus into the gripping cavity 50, making its lateral edges 101 bear on the sealing elements 35.

If necessary, after the electronic apparatus 100 has been positioned in the gripping cavity 50, the size of the gripping cavity 50 may be further regulated by moving the first 5 and the second 6 portion of the body 2 relative to one another.

In the transformation from the compact configuration W to the operating configuration Y and vice versa, the faces 20A, 21A of each appendage slide relative to the respective inclined edges 3, 4.

1. A support (1) for portable electronic apparatuses, comprising a body (2) having a mainly longitudinal development along a longitudinal axis (X) delimited by a longitudinally opposed first (3) and second edge (4), a first and a second gripping appendage (20, 21) provided on opposite ends of said body (2) and each having a face (20A, 21A) facing said first and said second edge (3, 4) respectively and shaped so as to be coupled with a positive coupling to said respective edge (3, 4), connecting means (23, 24, 25, 27) for operatively connecting said first and second gripping appendages (20, 21) to said body (2), said connecting means (23, 24, 25, 27) being shaped to allow said first and second appendage (20, 21) to rotate relative to said body (2) about an axis of rotation (Z′), wherein said first and second edge (3, 4) are inclined relative to said longitudinal axis (X) at an angle of (α)≤45°, said axis of rotation (Z′) being perpendicular to said first (3) and second edge (4), so that, by means of the rotation, said first (20) and second gripping appendage (21) can be rotated relative to said body (2) between a compact transport configuration (W), in which said first (20) and second gripping appendage (21) are aligned with said body (2), and a operating configuration (Y), in which said first (20) and second gripping appendage (21) are positioned transversely relative to said body (2).

2. The support according to claim 1, wherein said angle (α) is equal to about 45°.

3. The support according to claim 1, wherein said connecting means (23) comprises a screw (24) operatively interposed between said body (2) and said first (20) and second gripping appendage (21) respectively, said screw (24) being rotatable relative to one of said first (20) and second gripping appendage (21) and said body (2).

4. The support according to claim 3, wherein said screw (24) comprises a head (27) and a threaded body (25) extending from said head (27) along its own longitudinal axis (Z′).

5. The support according to claim 4, wherein said head (27) is slidably housed in a seat (28) defined in the first (5) or in the second portion (6) respectively, and said threaded body (25) is inserted into a fastening seat (26) provided in said first (20) or said second (21) gripping appendage respectively.

6. The support according to claim 5, wherein said screw (24) comprises a threaded body (25) extending along its own longitudinal axis which substantially coincides with said axis of rotation (Z′).

7. The support according to claim 1, wherein said body (2) is telescopic and comprises a plurality of sliding elements (5, 6) which are movable relative to one another to vary the overall length of said body (2) along said longitudinal axis (X).

8. The support according to claim 7, further comprising a locking device (10, 11) for locking said sliding elements (5, 6) in a desired position relative to one another.

9. The support according to claim 5, further comprising an elastic tensioning device housed in the body (2) and operatively interposed between said first (20) and second gripping appendage (21), said tensioning device being shaped so as to pull said first (20) and second gripping appendage (21) towards one another and press them against said body (2).

10. The support according to claim 1, further comprising a regulating device (60) for regulating the relative orientation between said gripping appendages (20, 21) and said body (2) and for locking the relative rotation between said gripping appendages (20, 21) and the body (2).

11. The support according to claim 10, wherein said regulating device (60) comprises, for each gripping appendage (20, 21), a pair of balls (61, 61A) each pushed by a respective spring (62, 62A) so as to project partially from said face (20A, 21A) or from said inclined edge (3, 4), and a pair of recesses (63, 63A) formed on said inclined edge (3, 4) or on said face, respectively, and positioned to receive said balls (61, 61A).

12. The support according to claim 11, wherein said balls (61, 61A) and said recesses (63, 63A) are positioned at 180° to one another relative to said axis of rotation (Z′).

13. The support according to claim 1, further comprising a fastening element (50) for fastening the support (1) to a support apparatus, a tripod or a monopod.

14. The support according to claim 1, further comprising a sealing element (35) positioned on the lateral wall (30, 31) of each gripping appendage (20, 21), designed to be turned in the operating configuration (Y) towards the other gripping appendage (20, 21), and designed to receive and support a lateral edge (101) of a piece of electronic apparatus (100).

15. The support according to claim 14, wherein said sealing element (35) is made of rubber or other material which is deformable and/or has a good coefficient of friction.

16. The support according to claim 14, wherein said sealing element (35) is positioned so as to project from said lateral wall (30, 31).

17. The support according to claim 14, wherein said sealing element (35) has an outer profile (35A) that is concave to facilitate positioning of the electronic equipment (100).

18. The support according to claim 1, wherein said body (2) is provided with at least one insert of rubber or other suitable material, designed to improve the gripping of the electronic apparatus (100) on said support.
